(19) United States
(12) Patent Application Publication
(10) Pub. No.: US 2026/0104031 A1
(43) Pub. Date: Apr. 16, 2026

(54) SYSTEM AND METHOD FOR REDUCING POWER CHANGES ON A DRIVETRAIN OF A POWER GENERATING ASSET DURING A GRID EVENT

(71) Applicant: General Electric Renovables España, S.L., Barcelona (ES)

(72) Inventors: Dustin Howard, Brookhaven, GA (US); Fernando Arturo Ramirez Sanchez, Salem, VA (US); Alfredo Sebastian Achilles, Niskayuna, NY (US)

(21) Appl. No.: 19/114,835

(22) PCT Filed: Sep. 26, 2022
(86) PCT No.: PCT/US2022/044672

§ 371 Date: Mar. 25, 2025

(51) Int. Cl. F03D 7/02; H02J 3/38; H02J 101/28

(52) U.S. Cl. CPC F03D 7/0284; H02J 3/381; F05B 2260/903; F05B 2270/1071; F05B 2270/337; H02J 2101/28

(57) ABSTRACT

A method for controlling a power generating asset connected to an electrical grid includes receiving, via a controller, a grid power limit associated with one or more grid events occurring in the electrical grid. During the one or more grid events, the method includes implementing, via the controller, a power softening function. The power softening function includes increasing a power command of a generator above the grid power limit to avoid large changes in power of the generator, thereby reducing a likelihood of coupling slips of the drivetrain and diverting extra power generated during the one or more grid events to an energy buffer of the power converter based on an energy buffer power command, thereby maintaining a net power generated by the power generating asset within the grid power limit.

### FIELD

The present disclosure relates in general to power generation, and more particularly to systems and methods for reducing power changes on a drivetrain of a power generating asset during a grid event.

### BACKGROUND

Power generating assets may take a variety of forms and rely on renewable and/or nonrenewable sources of energy. Those power generating assets relying on renewable sources of energy may generally be considered one of the cleanest, most environmentally friendly energy sources presently available. For example, wind turbines have gained increased attention in this regard. A modern wind turbine typically includes a tower, a generator, a gearbox, a nacelle, and one or more rotor blades. The nacelle includes a rotor coupled to the gearbox and to the generator. The rotor and the gearbox are mounted on a bedplate support frame located within the nacelle. The rotor blades capture kinetic energy of wind using known airfoil principles. The rotor blades transmit the kinetic energy in the form of rotational energy so as to turn a shaft coupling the rotor blades to the gearbox, or if the gearbox is not used, directly to the generator. The generator then converts the mechanical energy to electrical energy and the electrical energy may be transmitted to a converter and/or a transformer housed within the tower and subsequently deployed to a utility grid. Modern wind power generation systems typically take the form of a wind farm having multiple wind turbine generators that are operable to supply power to a transmission system providing power to an electrical grid.

Wind turbines can be distinguished in two types: fixed speed and variable speed turbines. Conventionally, variable speed wind turbines are controlled as current sources connected to an electrical grid. In other words, the variable speed wind turbines rely on a grid frequency detected by a phase locked loop (PLL) as a reference and inject a specified amount of current into the grid. The conventional current source control of the wind turbines is based on the assumptions that the grid voltage waveforms are fundamental voltage waveforms with fixed frequency and magnitude and that the penetration of wind power into the grid is low enough so as to not cause disturbances to the grid voltage magnitude and frequency. Thus, the wind turbines simply inject the specified current into the grid based on the fundamental voltage waveforms.

Grid faults, such as low-voltage ride through (LVRT) and/or zero-voltage ride through (ZVRT) events, produce large transient torques in the mechanical drive train of the wind turbine power system. For example, these torque events can reach large magnitudes that can damage the gearbox. Accordingly, existing drivetrain designs for wind turbine power systems typically rely on a slip coupling for protection of the gearbox. However, the slip coupling can wear out quickly and can be expensive to replace.

In view of the foregoing, the art is continuously seeking new and improved systems and methods for reducing power changes on the drivetrain of the wind turbine power system during a grid event.

### BRIEF DESCRIPTION

Aspects and advantages of the invention will be set forth in part in the following description, or may be obvious from the description, or may be learned through practice of the invention.

In an aspect, the present disclosure is directed to a method for controlling a power generating asset connected to an electrical grid. The power generating asset has a power converter and a drivetrain with a generator. The method includes receiving, via a controller, a grid power limit associated with one or more grid events occurring in the electrical grid. During the one or more grid events, the method includes implementing, via the controller, a power softening function. The power softening function includes increasing a power command of the generator above the grid power limit to avoid large changes in power of the generator, thereby reducing a likelihood of coupling slips of the drivetrain. The power softening function includes also diverting extra power generated during the one or more grid events to an energy buffer of the power converter based on an energy buffer power command, thereby maintaining a net power generated by the power generating asset within the grid power limit.

In an aspect, the present disclosure is directed to a power generating asset connected to an electrical grid. The power generating asset includes a generator, a power converter coupled to the generator, and a controller having at least one processor configured to perform a plurality of operations. The plurality of operations include receiving a grid power limit associated with one or more grid events occurring in the electrical grid. During the one or more grid events, the method includes implementing a power softening function. The power softening function includes increasing a power command of the generator above the grid power limit to avoid large changes in power of the generator, thereby reducing a likelihood of coupling slips of the drivetrain. The power softening function also includes diverting extra power generated during the one or more grid events to an energy buffer of the power converter based on an energy buffer power command, thereby maintaining a net power generated by the power generating asset within the grid power limit.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of an embodiment of a power generating asset configured as a wind turbine power system according to the present disclosure;

FIG. 2 illustrates a schematic diagram of an embodiment of an electrical system for use with a power generating asset configured as a wind turbine power system according to the present disclosure;

FIG. 3 illustrates a block diagram of an embodiment of a controller for use with a power generating asset according to the present disclosure;

FIG. 4 illustrates a simplified, schematic diagram of the electrical system of FIG. 2, particularly illustrating power flow during normal operations and during one or more grid events according to the present disclosure;

FIG. 5 illustrates a flow diagram of one embodiment of a method for controlling a power generating asset connected to an electrical grid according to the present disclosure;

FIG. 6 illustrates a schematic diagram of an embodiment of a power softening function according to the present disclosure;

FIG. 7 illustrates a schematic diagram of integration of an energy buffer power command from a power softening function into existing controls of the power generating asset according to the present disclosure; and

FIG. 8 illustrates a schematic diagram of integration of a power command from a power softening function into existing controls of the power generating asset according to the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “coupled,” “fixed,” “attached to,” and the like refer to both direct coupling, fixing, or attaching, as well as indirect coupling, fixing, or attaching through one or more intermediate components or features, unless otherwise specified herein.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

Grid events, such as low-voltage ride through (LVRT) and/or zero-voltage ride through (ZVRT) events, produce large transient torques in the mechanical drive train of a wind turbine power system that can damage the gearbox. Accordingly, existing drivetrain designs for wind turbine power systems typically rely on a slip coupling to meet LVRT/ZVRT requirements. In particular, the slip coupling may be installed for protection of the gearbox. However, the slip coupling can wear out quickly and can be expensive to replace.

Accordingly, the present disclosure is directed to systems and methods for controlling a power generating asset, such as a wind turbine, connected to an electrical grid that simultaneously commands a non-zero power command (causing active current to flow in the generator stator) and an energy buffer, such as a dynamic brake, to operate. As such, converter controls have the capability to reduce power changes on the drivetrain due to grid events by dissipating power in the energy buffer during a grid fault, thereby providing an increased margin on the drivetrain components for loads. The power command can be used to increase generator torque when the grid power is being constrained during a fault, whereas a coordinated power command can be sent to the energy buffer to provide power buffering for the extra power generated during the grid event. Such buffering may include storing and/or dissipating the generated power. Thus, systems and methods of the present disclosure effectively circulate active current from the generator stator through the line side converter of the power converter to provide a net-zero active current to the grid during grid events.

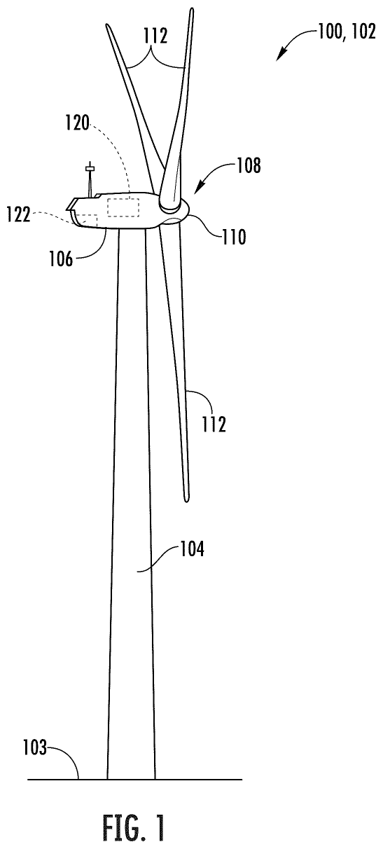

Referring now to the drawings, FIG. 1 illustrates a perspective view of one embodiment of a power generating asset 100 according to the present disclosure. As shown, the power generating asset 100 may be configured as a wind turbine 102. In an additional embodiment, the power generating asset 100 may, for example, be configured as a hydroelectric plant, a fossil fuel generator, and/or a hybrid power generating asset.

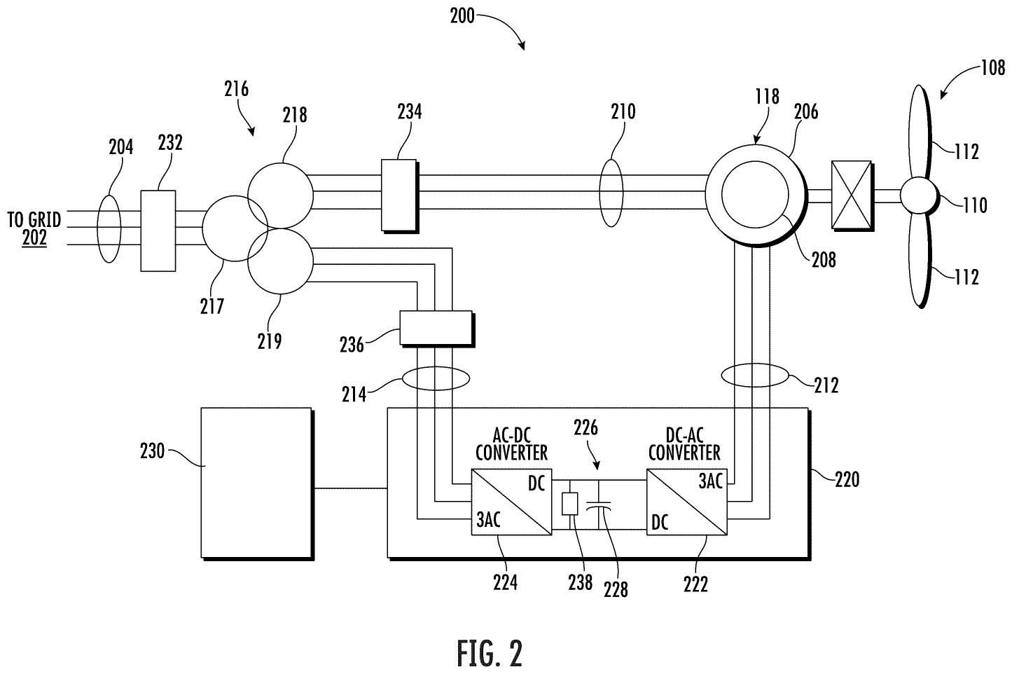

When configured as a wind turbine 102, the power generating asset 100 may generally include a tower 104 extending from a support surface 103, a nacelle 106 mounted on the tower 104, and a rotor 108 coupled to the nacelle 106. The rotor 108 includes a rotatable hub 110 and at least one rotor blade 112 coupled to and extending outwardly from the hub 110. For example, in the illustrated embodiment, the rotor 108 includes three rotor blades 112. However, in an alternative embodiment, the rotor 108 may include more or less than three rotor blades 112. Each rotor blade 112 may be spaced about the hub 110 to facilitate rotating the rotor 108 to enable kinetic energy to be transferred from the wind into usable mechanical energy, and subsequently, electrical energy. For instance, the hub 110 may be rotatably coupled to an electric generator 118 (FIG. 2) of an electrical system 200 (FIG. 2) positioned within the nacelle 106 to permit electrical energy to be produced.

The wind turbine 102 may also include a controller 120 centralized within the nacelle 106. However, in other embodiments, the controller 120 may be located within any other component of the wind turbine 102 or at a location outside the wind turbine 102. Further, the controller 120 may be communicatively coupled to any number of the components of the wind turbine 102 in order to control the components. As such, the controller 120 may include a computer or other suitable processing unit. Thus, in several embodiments, the controller 120 may include suitable computer-readable instructions that, when implemented, configure the controller 120 to perform various different functions, such as receiving, transmitting and/or executing wind turbine control signals.

Furthermore, as depicted in FIG. 1, in an embodiment, the power generating asset 100 may include at least one operational sensor 122. The operational sensor(s) 122 may be configured to detect a performance of the power generating asset 100, e.g., in response to the environmental condition. In an embodiment, the operational sensor(s) 122 may be configured to monitor a plurality of electrical conditions, such as slip, stator voltage and current, rotor voltage and current, line-side voltage and current, DC-link charge and/or any other electrical condition of the power generating asset 100.

It should also be appreciated that, as used herein, the term “monitor” and variations thereof indicates that the various sensors of the power generating asset 100 may be configured to provide a direct measurement of the parameters being monitored or an indirect measurement of such parameters. Thus, the sensor(s) 122 described herein may, for example, be used to generate signals relating to the parameter being monitored, which can then be utilized by the controller 120 to determine a condition or response of the power generating asset 100.

Referring now to FIG. 2, wherein an exemplary electrical system 200 of the power generating asset 100 is illustrated. As shown, the generator 118 may be coupled to the rotor 108 for producing electrical power from the rotational energy generated by the rotor 108. Accordingly, in an embodiment, the electrical system 200 may include various components for converting the kinetic energy of the rotor 108 into an electrical output in an acceptable form to an electrical grid 202 via grid bus 204. For example, in an embodiment, the generator 118 may be a double-fed induction generator (DFIG) having a stator 206 and a generator rotor 208. The generator 118 may be coupled to a stator bus 210 and a power converter 220 via a rotor bus 212. In such a configuration, the stator bus 210 may provide an output multiphase power (e.g., three-phase power) from a stator of the generator 118, and the rotor bus 212 may provide an output multiphase power (e.g., three-phase power) of the generator rotor 208 of the generator 118. Additionally, the generator 118 may be coupled via the rotor bus 212 to a rotor side converter 222. The rotor side converter 222 may be coupled to a line-side converter 224 which, in turn, may be coupled to a line-side bus 214.

In an embodiment, the rotor side converter 222 and the line-side converter 224 may be configured for normal operating mode in a three-phase, pulse width modulation (PWM) arrangement using insulated gate bipolar transistors (IGBTs) Other suitable switching devices may be used, such as insulated gate commuted thyristors, MOSFETs, bipolar transistors, silicone-controlled rectifiers, and/or other suitable switching devices. Furthermore, as shown, the rotor side converter 222 and the line-side converter 224 may be coupled via a DC link 226 across a DC link capacitor 228. In addition, as shown, the power converter 220 may include an energy buffer, such as a dynamic brake 238.

In an embodiment, the power converter 220 may be coupled to the controller 120 configured as a converter controller 230 to control the operation of the power converter 220. For example, the converter controller 202 may send control commands to the rotor side converter 222 and the line-side converter 224 to control the modulation of switching elements used in the power converter 220 to establish a desired generator torque setpoint and/or power output.

As further depicted in FIG. 2, the electrical system 200 may, in an embodiment, include a transformer 216 coupling the power generating asset of 100 to the electrical grid 202. The transformer 216 may, in an embodiment, be a three-winding transformer which includes a high voltage (e.g., greater than 12 KVAC) primary winding 217. The high voltage primary winding 217 may be coupled to the electrical grid 179. The transformer 216 may also include a medium voltage (e.g., 6 KVAC) secondary winding 218 coupled to the stator bus 210 and a low voltage (e.g., 575 VAC, 690 VAC, etc.) auxiliary winding 219 coupled to the line bus 214. It should be appreciated that the transformer 216 can be a three-winding transformer as depicted, or alternatively, may be a two-winding transformer having only the primary winding 217 and the secondary winding 218; may be a four-winding transformer having the primary winding 217, the secondary winding 218, the auxiliary winding 219, and an additional auxiliary winding; or may have any other suitable number of windings.

In an embodiment, the electrical system 200 may include various protective features (e.g., circuit breakers, fuses, contactors, and other devices) to control and/or protect the various components of the electrical system 200. For example, the electrical system 200 may, in an embodiment, include a grid circuit breaker 232, a stator bus circuit breaker 234, and/or a line bus circuit breaker 236. The circuit breaker(s) 232, 234, 236 of the electrical system 200 may connect or disconnect corresponding components of the electrical system 200 when a condition of the electrical system 200 approaches a threshold (e.g., a current threshold and/or an operational threshold) of the electrical system 200.

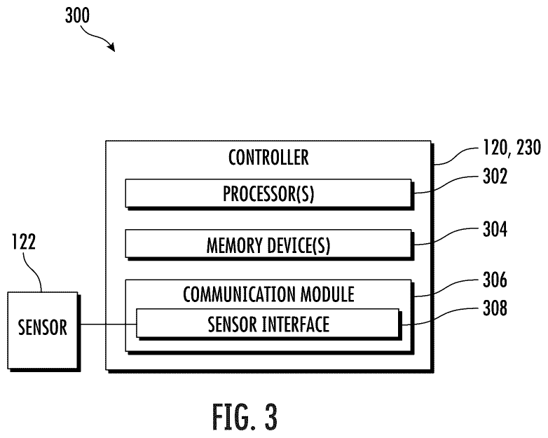

Referring now to FIG. 3, a block diagram of an embodiment of suitable components that may be included within a controller 300 of the power generating asset 100, such as the wind turbine 102, is illustrated. For example, as shown, the controller 300 may be the turbine controller 120 or the converter controller 230. Further, as shown, the controller 120 includes one or more processor(s) 302 and associated memory device(s) 304 configured to perform a variety of computer-implemented functions (e.g., performing the methods, steps, calculations and the like and storing relevant data as disclosed herein). Additionally, the controller 300, may also include a communications module 306 to facilitate communications between the controller 300, and the various components of the power generating asset 100. Further, the communications module 306 may include a sensor interface 308 (e.g., one or more analog-to-digital converters) to permit signals transmitted from the sensor(s) 122 to be converted into signals that can be understood and processed by the processors 302. It should be appreciated that the sensor(s) 122 may be communicatively coupled to the communications module 306 using any suitable means. For example, the sensor(s) 122 may be coupled to the sensor interface 308 via a wired connection. However, in other embodiments, the sensor(s) 122 may be coupled to the sensor interface 308 via a wireless connection, such as by using any suitable wireless communications protocol known in the art.

As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory device(s) 304 may generally include memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory device(s) 304 may generally be configured to store suitable computer-readable instructions that, when implemented by the processor(s) 302, configure the controller 300 to perform various functions as described herein, as well as various other suitable computer-implemented functions.

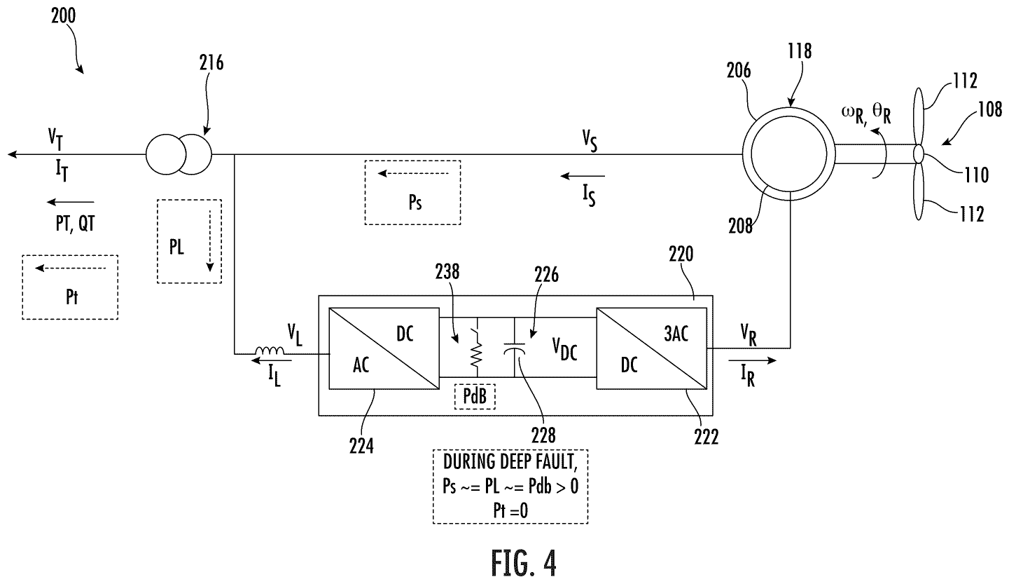

Referring now to FIG. 4, a simplified, schematic diagram of the electrical system 200 of FIG. 2 is illustrated, particularly illustrating power flow during normal operations and during one or more grid events according to the present disclosure. More specifically, as shown, the power flow during normal operations is represented by the solid arrows throughout the system 200, whereas the power flow during the grid event(s) is represented by the dotted arrows within the dotted boxes throughout the system 200. FIG. 4 further illustrates the dynamic brake 238 between the rotor side converter 222 and the line-side converter 224, represented as a resistor. Moreover, as shown, the power flow at the output of the system 200 (i.e., Pt and PT in FIG. 4) reflects the grid power/net power output of the system 200. Further, in an embodiment, the generator power is equal to the electric torque on the generator 118 multiplied by the operating speed, which is reflected as power flow through the stator and rotor windings of the generator 118. Most of the generator power flows through the stator (i.e., Ps in FIG. 4) during normal and grid-fault conditions.

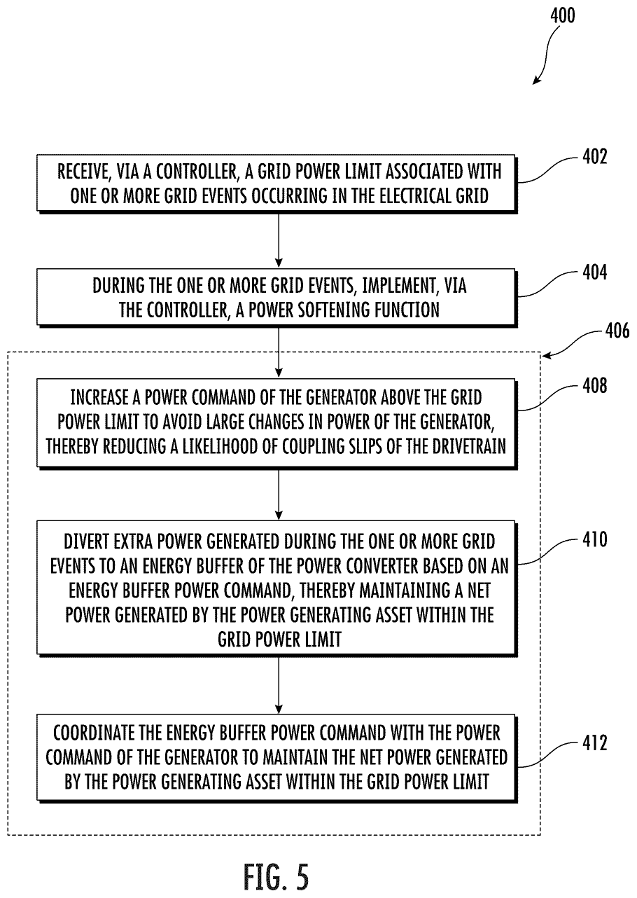

Referring now to FIG. 5, a flow diagram of one embodiment of a method 400 for controlling the power generating asset 100, particularly during a grid event, is presented. In particular embodiments, for example, the grid event may be a low-voltage ride through event (LVRT) or a zero-voltage ride through (ZVRT) event. In further embodiments, the grid event may be any event occurring in the grid that causes large changes in generator torque/power that lead to stresses on drivetrain components. The method 400 may be implemented using, for instance, the controller 300 of the present disclosure discussed above with references to FIGS. 2-4. FIG. 5 depicts steps performed in a particular order for purposes of illustration and discussion. Those of ordinary skill in the art, using the disclosures provided herein, will understand that various steps of the method 400, or any of the methods disclosed herein, may be adapted, modified, rearranged, performed simultaneously, or modified in various ways without deviating from the scope of the present disclosure.

As shown at (402), the method 400 may include receiving, via a controller, a grid power limit 502 (e.g., PwrLimGDPLPu) associated with one or more grid events occurring in the electrical grid. For example, in an embodiment, the method 400 may include computing the grid power limit as a function of a voltage feedback, a phase locked loop (PLL) error signal, or similar. By dynamically reducing the grid active power limit during grid events, together with prioritization of voltage support, the electrical stability of the grid may be improved. However, this prioritization of grid stability can have significant impact on the drivetrain components due to the large change in power/torque associated with the grid power limit activating. To help reduce this adverse effect on the large power/torque change on the drivetrain components, as shown at (404), the method 400 may include implementing, via the controller 300, a power softening function 406 during the grid event(s). For example, as shown (408), the power softening function 406 includes increasing a power command of the generator above the grid power limit to avoid large changes in power of the generator, thereby reducing a likelihood of coupling slips of the drivetrain.

Further, as shown at (410), the power softening function 406 includes diverting extra power generated during the grid event(s) to an energy buffer of the power converter based on an energy buffer power command. In particular embodiments, the power softening function 406 may include simultaneously increasing the power command of the generator and diverting the extra power generated during the grid event(s) to the energy buffer of the power converter based on the energy buffer power command. In certain embodiments, for example, the energy buffer may include the dynamic brake 238 of the power converter 200, one or more ultracapacitors, or an energy storage device.

Moreover, as shown at (412), the power softening function 406 includes coordinating the energy buffer power command with the power command of the generator to maintain the net power generated by the power generating asset within the grid power limit. Thus, the power softening function 406 is configured to prevent a generator power output of the generator from dropping to zero during the grid event(s), thereby decreasing a change in drivetrain power caused by the grid event(s).

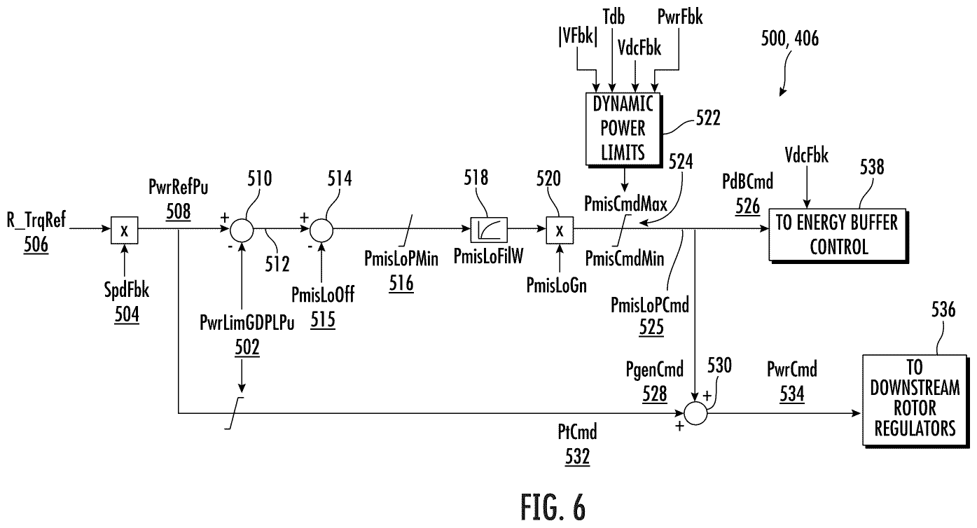

The method 400 of FIG. 5 can be better understood with reference to FIGS. 6-8. In particular, FIG. 6 illustrates a schematic diagram 500 of an embodiment of the power softening function 406 according to the present disclosure. As shown, the power softening function 406 receives a plurality of inputs. In particular embodiments, as shown, the plurality of inputs may include, for example, the grid power limit 502 (e.g., PwrLimGDPLPu), a speed feedback signal 504 (e.g., SpdFbk), a rotor torque reference 506 (R_TrqRef) of the wind turbine 102 (e.g., from turbine controller 120), a power reference of the wind turbine 102, or any other suitable input.

Thus, as shown, the power softening function 406 is configured to determine a power reference signal 508 as a function of the speed feedback signal 504 and the rotor torque reference 506. Furthermore, as shown, the power softening function 406 is configured to determine an error signal 512 using the plurality of inputs. More specifically, as shown at 510, the power reference signal 508 may be compared to the grid power limit 502 to determine the error signal 512, which is a difference between the power reference signal 508 and the grid power limit 502. During normal operations, the error signal 512 is negative since the grid power limit is above the operating power. However, during a grid fault, the error signal 512 increases to generate a plurality of outputs. In particular embodiments, for example, the error signal is used to generate the energy buffer power command 526 (e.g., PdBCmd) and a generator power output 528 (e.g., PgenCmd) described herein.

Referring still to FIG. 6, the power softening function 406 is further configured to process the error signal 512. For example, as shown, processing the error signal 512 may include comparing the error signal 512 to an offset 515 (e.g., PmisLoOff) via comparator 514, limiting the error signal 512 by applying a lower limit 516 (e.g., PmisLoPMin) to the error signal 512, and/or filtering the error signal 512 via a filter 518, such as a low pass filter. In such embodiments, for example, the offset 515 together with the lower limit 516 may assist with activating the power softening function 406 for more or less severe grid faults and for maintaining the power softening function 406 inactive during normal operating conditions. For example, the offset 515 may be set to a 0.3 PU (per unit) power and the lower limit 516 may be set to zero, which indicates the error signal 512 must be greater than 0.3 PU before the power softening function 406 becomes activated. Similarly, since the error signal 512 is negative during normal operating conditions, the lower limit 516 of zero will keep the power softening function 406 disabled during these conditions. Alternative settings can also be chosen to activate the power softening function 406 at smaller or larger power error settings.

In particular embodiments, as shown, the power softening function 406 is further configured to applying a gain 520 (e.g., PmisLoGn) to the error signal 512. Furthermore, as shown, the power softening function 406 is configured to apply one or more dynamic power limits 522 to the error signal 512. In such embodiments, for example, the dynamic power limit(s) 522 of the power softening function 406 may be calculated to avoid excessive power/energy consumption, to avoid overheating certain components, and/or to avoid a collapse in DC voltage. For example, in an embodiment, a dynamic power limit may be computed based on a magnitude of the voltage feedback (e.g., VFbk) multiplied by the maximum current limit of the line side converter 224, thereby constraining the power softening function 406 more as voltage drops lower to constraint currents within the limitations of the converter ratings. In other embodiments, the power limits may be fixed values. In other embodiments, the dynamic power limit(s) 522 may designed to constrain the power softening function 406 if certain feedbacks exceed at least one of a temperature limit, a power demand limit, a power consumption limit, a trip limit, a reverse power limit, a load limit, a voltage limit, or any other suitable limit. Thus, as shown, the dynamic limit(s) 522 can be applied to the error signal 512 via limiter 524 having maximum and minimum limits (e.g., PmisCmdMax and PmisCmdMin). Further, as shown, an output of the limit is a power command 525 (e.g., PmisLoPCmd). Accordingly, the power command 525 can be used to generate outputs of the power softening function 406, which are the energy buffer power command 526 (e.g., PdBCmd) and the generator power output 528 (e.g., PgenCmd).

Moreover, as shown at 530, the power softening function 406 is configured to sum the generator power command 528 with a grid power reference 532 (e.g., PtCmd) to generate a power command 534 (e.g., PwrCmd) that can be sent to downstream rotor regulators 536 to increase generator torque when the grid power is being constrained, e.g., during a grid fault. In addition, as shown at 538, the energy buffer power command 526 can be sent to energy buffer control. In such embodiments, the energy buffer power command 526 is configured to provide a power sink for the extra power generated during the grid event. In additional embodiments, the power softening function 406 is configured to coordinate the energy buffer power command 526 with the power command of the generator to maintain the net power generated by the power generating asset within the grid power limit.

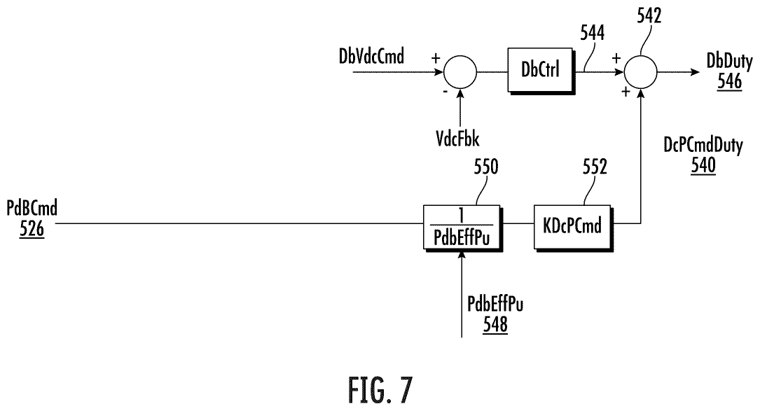

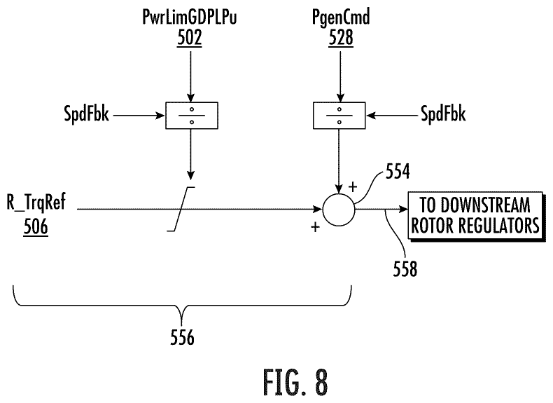

Referring now to FIGS. 7 and 8, schematic diagrams of integration of the outputs (e.g., the energy buffer power command 526 and the power command 534) from the power softening function 406 into existing controls of the power generating asset 100 according to the present disclosure are illustrated. In particular, FIG. 7 illustrates a schematic diagram of integration of the energy buffer power command 526 from the power softening function 406 into dynamic brake existing controls of the power generating asset 100 according to the present disclosure; whereas FIG. 8 illustrates a schematic diagram of integration of the power command 534 (e.g., PwrCmd) from the power softening function 406 into existing torque controls of the power generating asset 100 according to the present disclosure.

Referring particularly to FIG. 7, the power softening function 406 is configured to request the energy buffer power command 526. In such embodiments, the energy buffer power command 526 can be used to calculate a duty cycle command 540 (e.g., DcPCmdDuty) for the dynamic brake 238 (FIGS. 2 and 4). Thus, as shown at 542, the duty cycle command 540 can be summed with existing duty commands 544 from DB control to obtain a dynamic brake duty cycle signal 546 for the dynamic brake 238. In particular embodiments, the energy buffer power command 526 may be processed before being combined with the existing duty commands 544. For example, as shown at 550, a power dissipation capability signal 548 may be applied to the energy buffer power command 526 for determining a power command that is normalized on the power dissipation capability of the dynamic brake 238. Furthermore, as shown at 552, a gain may be applied to the energy buffer power command 526 before calculating the duty cycle command 540.

Referring particularly to FIG. 8, an alternative implementation of the generator power output 528 (e.g., PgenCmd) along a torque control may be used. For example, the generator power output 528 may be divided by a speed feedback signal (e.g., SpdFbk) to obtain a generator torque command. Thus, as shown at 554, the generator torque command may be summed to a torque command path 556 of existing controls during the grid event. Accordingly, an output 558 of the summator 554 can be used in downstream rotor regulators to regulate the generator torque.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Further aspects of the invention are provided by the subject matter of the following clauses:
A method for controlling a power generating asset connected to an electrical grid, the power generating asset having a power converter and a drivetrain with a generator, the method comprising: receiving, via a controller, a grid power limit associated with one or more grid events occurring in the electrical grid; during the one or more grid events, implementing, via the controller, a power softening function, the power softening function comprising: increasing a power command of the generator above the grid power limit to avoid large changes in power of the generator, thereby reducing a likelihood of coupling slips of the drivetrain; and diverting extra power generated during the one or more grid events to an energy buffer of the power converter based on an energy buffer power command, thereby maintaining a net power generated by the power generating asset within the grid power limit.
The method of any preceding clause, wherein the power softening function further comprises substantially simultaneously increasing the power command of the generator and diverting the extra power generated during the one or more grid events to the energy buffer of the power converter based on the energy buffer power command.
The method of any preceding clause, wherein the power softening function prevents a generator power output of the generator from dropping to zero during the one or more grid events, thereby decreasing a change in drivetrain power caused by the one or more grid events.
The method of any preceding clause, wherein the energy buffer comprises at least one of a dynamic brake of the power converter, one or more ultracapacitors, or an energy storage device.
The method of any preceding clause, further comprising computing the grid power limit as a function of at least one of a voltage feedback or a phase locked loop (PLL) error signal.
The method of any preceding clause, wherein the power softening function further comprises coordinating the energy buffer power command with the power command of the generator to maintain the net power generated by the power generating asset within the grid power limit.
The method of any preceding clause, wherein the power softening function further comprises: receiving, via the power softening function, a plurality of inputs; determining, via the power softening function, an error signal using the plurality of inputs; and generating, via the power softening function, a plurality of outputs based on the error signal, the plurality of outputs comprising the energy buffer power command and the power command of the generator.
The method of any preceding clause, wherein the plurality of inputs comprises at least one of the grid power limit, a speed feedback signal, a torque reference of the wind turbine, or a power reference of the wind turbine.
The method of any preceding clause, wherein the power softening function further comprises processing the error signal.
The method of any preceding clause, wherein processing the error signal further comprises at least one of offsetting the error signal, limiting the error signal, or filtering the error signal.
The method of any preceding clause, wherein the power softening function further comprises: computing one or more dynamic power limits based on one or more limit parameters; and applying the one or more dynamic power limits to the processed error signal.
The method of any preceding clause, wherein the one or more parameters comprise at least one of a temperature limit, a power demand limit, a power consumption limit, a trip limit, a reverse power limit, a load limit, a AC current limit, AC voltage feedback, or a DC voltage limit.
The method of any preceding clause, wherein the power generating asset is a wind turbine.
The method of any preceding clause, wherein the one or more grid events comprise one of a low-voltage ride through event (LVRT) or a zero-voltage ride through (ZVRT) event.
A power generating asset connected to an electrical grid, the power generating asset comprising: a generator; a power converter coupled to the generator; and a controller comprising at least one processor configured to perform a plurality of operations, the plurality of operations comprising: receiving a grid power limit associated with one or more grid events occurring in the electrical grid; during the one or more grid events, implementing a power softening function, the power softening function comprising: increasing a power command of the generator above the grid power limit to avoid large changes in power of the generator, thereby reducing a likelihood of coupling slips of the drivetrain; and diverting extra power generated during the one or more grid events to an energy buffer of the power converter based on an energy buffer power command, thereby maintaining a net power generated by the power generating asset within the grid power limit.
The power generating asset of any preceding clause, wherein the power softening function further comprises: substantially simultaneously increasing the power command of the generator and diverting the extra power generated during the one or more grid events to the energy buffer of the power converter based on the energy buffer power command, wherein the power softening function prevents a generator power output of the generator from dropping to zero during the one or more grid events, thereby decreasing a change in drivetrain power caused by the one or more grid events.
The power generating asset of any preceding clause, wherein the power softening function further comprises: coordinating the energy buffer power command with the power command of the generator to maintain the net power generated by the power generating asset within the grid power limit.
The power generating asset of any preceding clause, wherein the power softening function further comprises: receiving, via the power softening function, a plurality of inputs; determining, via the power softening function, an error signal using the plurality of inputs; and generating, via the power softening function, a plurality of outputs based on the error signal, the plurality of outputs comprising the energy buffer power command and the power command of the generator.
The power generating asset of any preceding clause, wherein the plurality of inputs comprises at least one of the grid power limit, a speed feedback signal, or a torque reference of the wind turbine, or a power reference of the wind turbine.
The power generating asset of any preceding clause, wherein the energy buffer comprises at least one of a dynamic brake of the power converter, one or more ultracapacitors, or an energy storage device.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for controlling a power generating asset connected to an electrical grid, the power generating asset having a power converter and a drivetrain with a generator, the method comprising:
receiving, via a controller, a grid power limit associated with one or more grid events occurring in the electrical grid;
during the one or more grid events, implementing, via the controller, a power softening function, the power softening function comprising:
increasing a power command of the generator above the grid power limit to avoid large changes in power of the generator, thereby reducing a likelihood of coupling slips of the drivetrain; and
diverting extra power generated during the one or more grid events to an energy buffer of the power converter based on an energy buffer power command, thereby maintaining a net power generated by the power generating asset within the grid power limit.

2. The method of claim 1, wherein the power softening function further comprises substantially simultaneously increasing the power command of the generator and diverting the extra power generated during the one or more grid events to the energy buffer of the power converter based on the energy buffer power command.

3. The method of claim 1, wherein the power softening function prevents a generator power output of the generator from dropping to zero during the one or more grid events, thereby decreasing a change in drivetrain power caused by the one or more grid events.

4. The method of claim 1, wherein the energy buffer comprises at least one of a dynamic brake of the power converter, one or more ultracapacitors, or an energy storage device.

5. The method of claim 1, further comprising computing the grid power limit as a function of at least one of a voltage feedback or a phase locked loop (PLL) error signal.

6. The method of claim 1, wherein the power softening function further comprises coordinating the energy buffer power command with the power command of the generator to maintain the net power generated by the power generating asset within the grid power limit.

7. The method of claim 6, wherein the power softening function further comprises:
receiving, via the power softening function, a plurality of inputs;
determining, via the power softening function, an error signal using the plurality of inputs; and
generating, via the power softening function, a plurality of outputs based on the error signal, the plurality of outputs comprising the energy buffer power command and the power command of the generator.

8. The method of claim 7, wherein the plurality of inputs comprises at least one of the grid power limit, a speed feedback signal, a torque reference of the wind turbine, or a power reference of the wind turbine.

9. The method of claim 7, wherein the power softening function further comprises processing the error signal.

10. The method of claim 9, wherein processing the error signal further comprises at least one of offsetting the error signal, limiting the error signal, or filtering the error signal.

11. The method of claim 9, wherein the power softening function further comprises:
computing one or more dynamic power limits based on one or more limit parameters; and
applying the one or more dynamic power limits to the processed error signal.

12. The method of claim 11, wherein the one or more parameters comprise at least one of a temperature limit, a power demand limit, a power consumption limit, a trip limit, a reverse power limit, a load limit, a AC current limit, AC voltage feedback, or a DC voltage limit.

13. The method of claim 1, wherein the power generating asset is a wind turbine.

14. The method of claim 1, wherein the one or more grid events comprise one of a low-voltage ride through event (LVRT) or a zero-voltage ride through (ZVRT) event.

15. A power generating asset connected to an electrical grid, the power generating asset comprising:
a generator;
a power converter coupled to the generator; and
a controller comprising at least one processor configured to perform a plurality of operations, the plurality of operations comprising:
receiving a grid power limit associated with one or more grid events occurring in the electrical grid;
during the one or more grid events, implementing a power softening function, the power softening function comprising:
increasing a power command of the generator above the grid power limit to avoid large changes in power of the generator, thereby reducing a likelihood of coupling slips of the drivetrain; and
diverting extra power generated during the one or more grid events to an energy buffer of the power converter based on an energy buffer power command, thereby maintaining a net power generated by the power generating asset within the grid power limit.

16. The power generating asset of claim 15, wherein the power softening function further comprises:
substantially simultaneously increasing the power command of the generator and diverting the extra power generated during the one or more grid events to the energy buffer of the power converter based on the energy buffer power command,
wherein the power softening function prevents a generator power output of the generator from dropping to zero during the one or more grid events, thereby decreasing a change in drivetrain power caused by the one or more grid events.

17. The power generating asset of claim 15, wherein the power softening function further comprises:
coordinating the energy buffer power command with the power command of the generator to maintain the net power generated by the power generating asset within the grid power limit.

18. The power generating asset of claim 17, wherein the power softening function further comprises:
receiving, via the power softening function, a plurality of inputs;
determining, via the power softening function, an error signal using the plurality of inputs; and
generating, via the power softening function, a plurality of outputs based on the error signal, the plurality of outputs comprising the energy buffer power command and the power command of the generator.

19. The power generating asset of claim 18, wherein the plurality of inputs comprises at least one of the grid power limit, a speed feedback signal, or a torque reference of the wind turbine, or a power reference of the wind turbine.

20. The power generating asset of claim 15, wherein the energy buffer comprises at least one of a dynamic brake of the power converter, one or more ultracapacitors, or an energy storage device.
